(19) United States
(12) Patent Application Publication
(10) Pub. No.: US 2005/0198836 A1
(43) Pub. Date: Sep. 15, 2005

(54) Electrical knife

(76) Inventors: Ingo Thiele, Wuppertal (DE); Hannes Mayer, Wuppertal (DE)

Correspondence Address: Hoffman, Wasson & Gitler, P.C.;Crystal Center 2, Suite 522, 2461 South Clark Street, Arlington, VA, 22202, US

(21) Appl. No.: 11/062,761

(22) Filed: Feb. 23, 2005

(30) Foreign Application Priority Data
Feb. 23, 2004 (DE) 102004009033.5

(51) Int. Cl. B26B 15/00

(52) U.S. Cl. 30/277.4

(57) ABSTRACT

Electrical knife having an elongate cutting device and an electric motor, the cutting device having a first blade and a second blade which is arranged parallel to said first blade, which blades are suitable for the electric motor to importing them a counter-rotating oscillating movement in the direction of their longitudinal axis, the cutting device also being equipped with a fixed guide tongue which at least partly extends along the blades and which is suitable for guiding the blades in the longitudinal direction.

### BACKGROUND OF THE INVENTION

The present invention relates to an electrical knife with an elongate cutting device and an electric motor.

An electrical knife of the abovementioned type is sufficiently known. In this case, the cutting device used is principally two elongate blades which are arranged in parallel, are driven by an electric motor and execute an oscillating translatory movement with respect to one another. As a result of this, the cutting teeth of the blades sever the product to be cut at the desired location.

Handling of the electrical knife is extremely disadvantageous due to an inadequate connection between the housing and the cutting device, and due to the cutting device being highly susceptible to bending. This disadvantage may lead to inaccurate cutting and possibly even to injuries.

This is where the present invention comes in and sets itself the object of providing an electrical knife which is distinguished by improved handling and in which the risk of injuries can be minimized.

### SUMMARY OF THE INVENTION

According to the invention, an object is achieved by an electrical knife having blades which exhibit a counter-rotating, oscillating movement in the direction of their longitudinal axis. The handling and cutting accuracy of the electrical knife are substantially improved by the fact that the cutting device is additionally equipped with a fixed guide tongue which at least partly extends along the blades and which is suitable for guiding the blades in the longitudinal direction. The cutting device is stabilized by the guide tongue. In particular, lateral forces which occur during the cutting process can now be diverted onto the guide tongue, as a result of which bending of the blades can be avoided. Also, the electrical knife, and in particular the cutting device, may be of relatively compact design since the stability of the blades is ensured principally by the guide tongue.

For cleaning and maintenance purposes, provision may advantageously be made for the cutting device to be releasably connected to the housing. Alternative cutting devices can also be connected to one and the same housing and/or one and the same electric motor.

Provision may furthermore advantageously be made for the releasable connection to be produced by a connection device which is both suitable for coupling the electric motor to the cutting device in order to convert the driving movement, and is also suitable for producing a releasable connection to the housing. In this preferred embodiment, the rotary movement of the electric motor is converted into the oscillating translatory movement of the blades in the connection device itself, that is to say, the entire cutting device, including connection unit, can be detached and cleaned separately. Also, an alternative apparatus can now be attached, for example a mixer or another kitchen appliance.

In order to facilitate handling, an operating element can be provided using which the connection device can be operated in order to release the connection. As a result, secure fixing of the cutting device to the housing can be ensured and can be released only by the user. In this regard, provision may furthermore advantageously be made for the operating element to be equipped with a safety means so that it can only be operated when the electric motor is not connected to the mains.

In one advantageous refinement of the guide tongue, it is provided that the guide tongue has a U-shaped cross section and at least partially surrounds the blades.

As an alternative to this, it may be provided that the guide tongue is arranged between the blades. Both embodiments are conceivable in order to ensure high lateral stability of the blades.

Also with regard to the guide tongue, it may advantageously be provided that the guide tongue comprises at least one first half tongue and one second half tongue, these half tongues being releasably connected to one another. The guide tongue may accordingly also be dismantled for cleaning and/or maintenance purposes.

It may furthermore advantageously also be arranged that a connecting means is provided on that side of the guide tongue which faces away from the connection device, this connecting means being suitable for suspending the blades in the guide tongue. This measure provides an additional guiding means which secures the blades in the guide tongue on the side which faces away from the housing.

For this purpose, it may advantageously be provided that the connecting means is configured as an elongate slot in the region of the tip of the blades, it being possible for the guide tongue to hold the elongate slot during the entire oscillating longitudinal movement of the blades.

As an alternative, it may likewise be provided that the connecting means is configured as a cutout in the region of the tip of the guide tongue in which a corresponding shaped element which is provided on the blades can be held during the entire oscillating longitudinal movement of the blades. The stability of the cutting device can be further increased by a connecting means provided at the ends of the blades and/or of the guide tongue.

In one advantageous development of the present invention, it is provided that the cutting device is oriented at a slight angle, preferably at an angle of 6° to 10°, in relation to the longitudinal axis of the housing. This provides optimal adaptation to the ergonomics of the wrist. The slight angling means that the hand does not have to be stretched in an unnatural manner.

Also, it may furthermore be provided that the base of the electrical knife is equipped with a runner. This ensures that the electrical knife is set down safely.

### BRIEF DESCRIPTION OF THE DRAWINGS

Further features and advantages of the present invention will become clear from the following description of preferred exemplary embodiments with reference to the attached drawings, in which:

FIG. 1 shows a side view of an electrical knife according to the invention;

FIG. 2 shows a side view of a cutting device of an electrical knife according to the invention;

FIG. 2a shows a sectional view in accordance with section Ila from FIG. 2;

FIG. 3 shows an exploded illustration of a cutting device of an electrical knife according to the invention;

FIG. 4 shows a side view of a cutting device of an electrical knife according to the invention;

FIG. 5 shows an exploded illustration of an alternative embodiment of the cutting device of an electrical knife according to the invention;

FIG. 6 shows a side view of an alternative embodiment of the cutting device of an electrical knife according to the invention;

FIG. 7 shows an exploded illustration of an alternative embodiment of the cutting device of an electrical knife according to the invention; and

FIG. 8 shows a connection device for an electrical knife according to the invention.

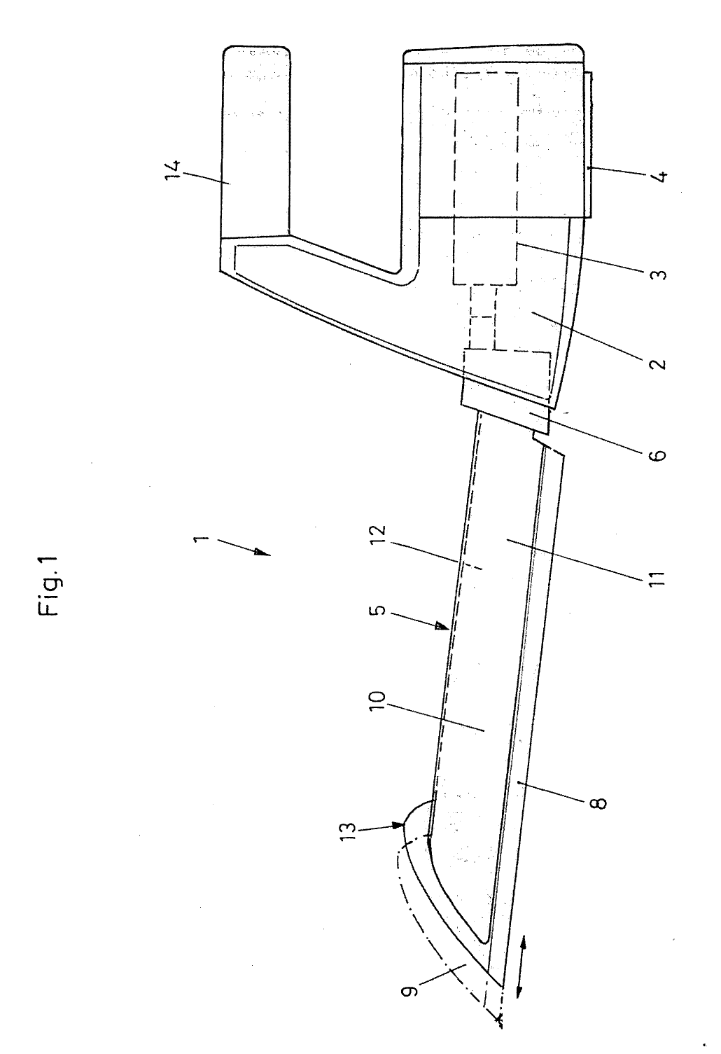

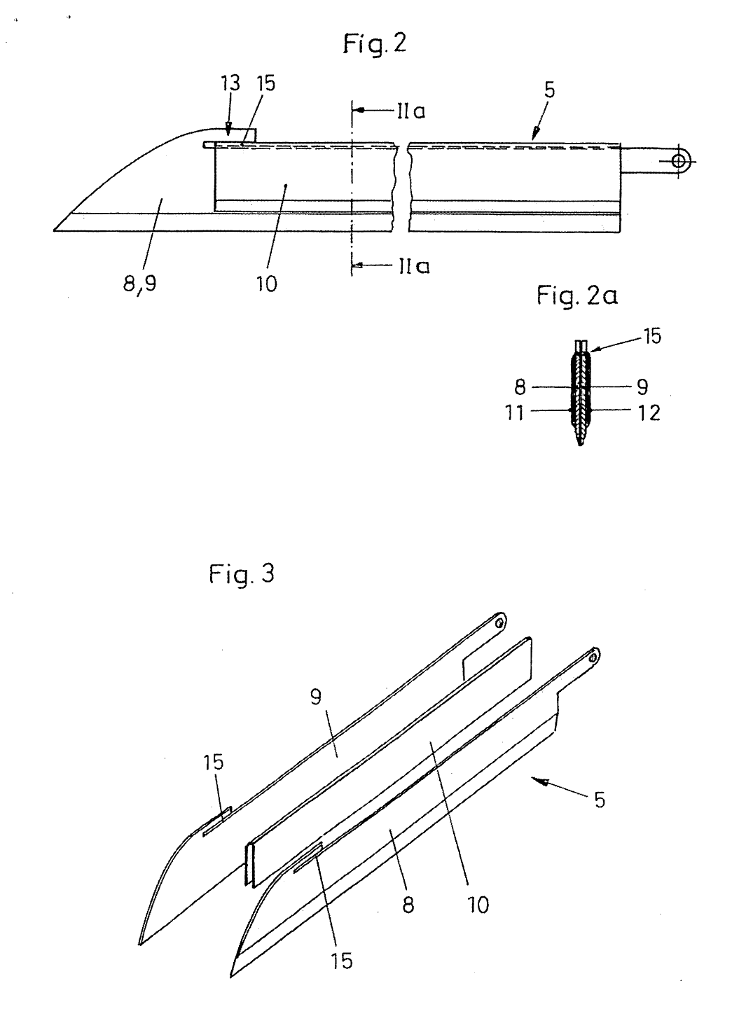

### DETAILED DESCRIPTION OF THE INVENTION

An electrical knife 1 according to the invention, includes a housing 2 having an electric motor 3, a handle 14, a runner 4, a connection device 6 and a cutting device 5.

The housing 2 is principally a plastic housing which is preferably integrally formed together with the handle 14. The runner 4 is provided in order to set down the electrical knife 1.

The cutting device 5 includes a first blade 8 and a second blade 9 and also a guide tongue 10. The blades 8, 9 are elongate knife blades which are preferably equipped with serrations along one elongate side edge. However, other cutting edges, apart from the serrations, are also conceivable.

The guide tongue 10 has a U-shaped cross section and extends over the length of the blades 8, 9. Said guide tongue thus forms a guiding groove for the blades 8, 9 so that they can be displaceably held in the direction of movement. Equally, the blades 8, 9 are guided laterally and counter to the direction of cutting by the guiding groove so that the blades 8, 9 cannot be bent by lateral forces which occur.

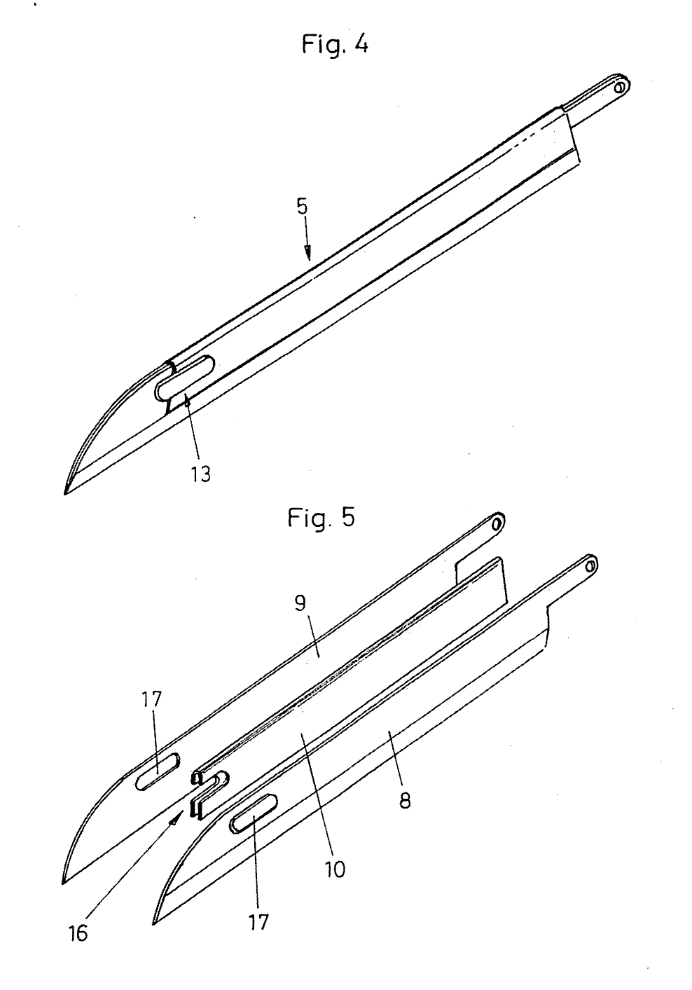

The ends of the blades 8, 9 are advantageously equipped with further guiding means 13 which can engage in a suitable holding device of the guide tongue 10. In the preferred embodiment of the present invention illustrated here, the guiding means 13 is designed as a slot 15 in the ends of the blades 8, 9, which slot can engage into the guide tongue 10. This provides further guidance of the blades 8, 9 at the ends. Other alternative embodiments of the guiding means 13 can be found in FIGS. 4 and 5, for example. In these figures, the blades are equipped with a shaped element 17 which engages into a cutout 16, which is provided for said shaping element, in the guide tongue 10.

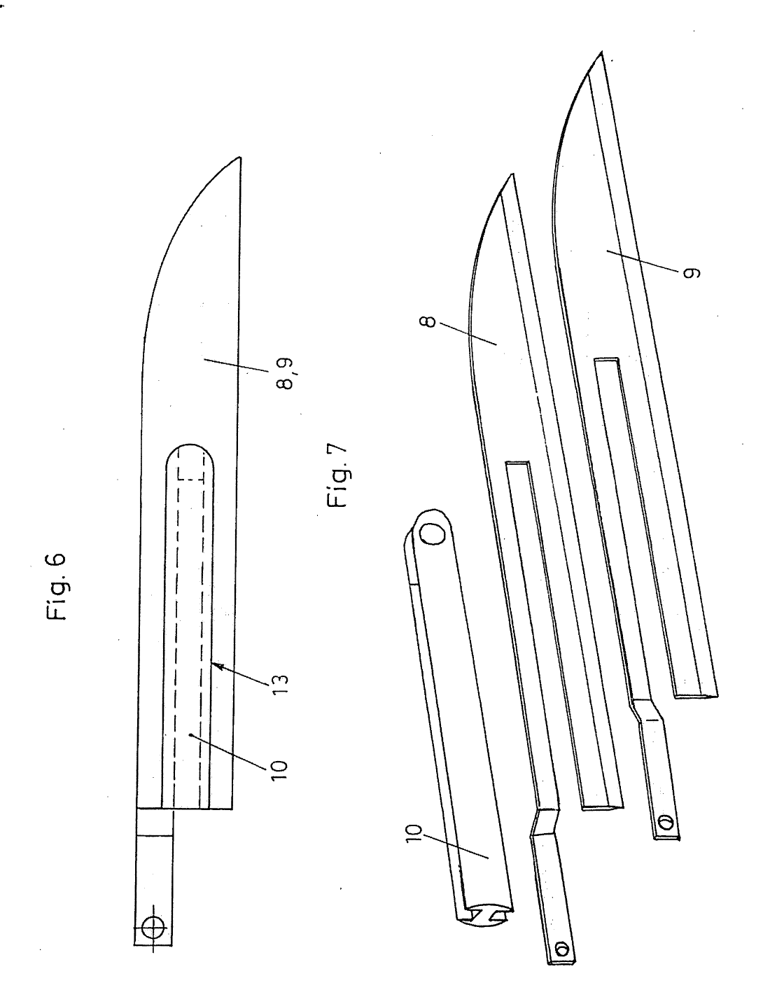

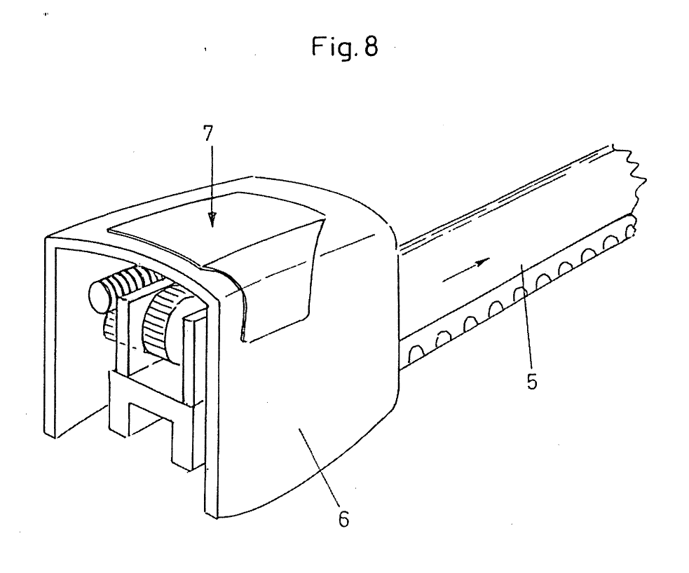

The guide tongue 10 advantageously comprises a first half tongue 11 and a second half tongue 12, these half tongues being releasably connected to one another in a suitable manner. In order to clean the cutting device 5, it may be dismantled into its main constituent parts, in particular into the first and second blades 8, 9 and into the two half tongues 11, 12. FIGS. 6 and 7 show an alternative embodiment of the guide tongue 10 which is arranged between the blades 8, 9.

Furthermore, a connection device 6 is provided by means of which the cutting device 5 is releasably connected to the housing 2 and/or to the drive device 3. The connection device 6 essentially has to fulfill two functions. Firstly, the rotary movement of the electric motor 3 has to be converted into a translatory oscillating movement and transferred to the blades 8, 9. To this end, an arrangement is provided which comprises a pinion with eccentrically arranged driving pins, it being possible to attach a worm shaft of the electric motor 3 to the pinion, and for the driving pins to engage into corresponding cutouts in the blades 8, 9. Secondly, the entire cutting device 5 has to be releasably connected to the housing 2. For this purpose, the connection device 6 latches into place in the housing 2 by means of a suitable flange. The connection device 6 can be unlocked by means of an operating element 7 which is provided in the connection device 6, so that the cutting device 5 can be detached for maintenance purposes and/or can be replaced by an alternative cutting device 5 or even by another kitchen implement. Also conceivable is an alternative refinement of the connection device 6 which serves only to secure the cutting device 5, the rotary movement being converted within the housing, and the operating element 7 being attached on the housing side.

Provision is moreover made for the cutting device 5 to be oriented at a slight angle with respect to the handle 14 and/or to the housing 2. This measure again improves handling since the ergonomic requirements of the wrist are taken into account here.

1. An electrical knife having an elongate cutting device and an electric motor, the cutting device comprising a first blade and a second blade which is arranged parallel to said first blade, which blades are suitable for the electric motor to impart them a counter-rotating oscillating movement in the direction of their longitudinal axis, wherein the cutting device is also equipped with a fixed guide tongue which at least partly extends along the blades and which is suitable for guiding the blades in the longitudinal direction.

2. The electrical knife as claimed in claim 1, wherein the cutting device is releasably connected to the housing.

3. The electrical knife as claimed in claim 2, wherein the releasable connection is produced by a connection device which is both suitable for coupling the electric motor to the cutting device in order to convert the driving movement, and is also suitable for producing a releasable connection to the housing.

4. The electrical knife as claimed in claim 3, wherein an operating element is provided by which the connection device can be operated in order to release the connection.

5. The electrical knife as claimed in claim 1, wherein the guide tongue has a U-shaped cross section and at least partially surrounds the blades.

6. The electrical knife as claimed in claim 1 wherein the guide tongue is arranged between the blades.

7. The electrical knife as claimed in claim 1, wherein the guide tongue comprises at least one first half tongue and one second half tongue, these half tongues being releasably connected to one another.

8. The electrical knife as claimed in claim 3, wherein a guiding means is provided on that side of the guide tongue which faces away from the connection device, this guiding means being provided in order to suspend the blades in the guide tongue.

9. The electrical knife as claimed in claim 8, wherein the guiding means is configured as an elongate slot in the region of the tip of the blades the guide tongue holds the elongate slot during the entire oscillating longitudinal movement of the blades.

10. The electrical knife as claimed in claim 8, wherein the guiding means is configured as a cutout in the region of the tip of the guide tongue in which a shaped element which is provided on the blades can be held during the entire oscillating longitudinal movement of the blades.

11. The electrical knife as claimed in claim 1, wherein the cutting device is oriented at a slight angle in relation to the longitudinal axis of the housing.

12. The electrical knife as claimed in claim 1, wherein the base of the electrical knife is equipped with a runner.

13. The electrical knife as claimed in claim 11, wherein the slight angle ranges from 6° to 10°.
